(19) United States
(12) Patent Application Publication
(10) Pub. No.: US 2021/0133310 A1
(43) Pub. Date: May 6, 2021

(54) SYSTEMS AND METHODS FOR COMPUTER SECURITY

(71) Applicant: A7technology Inc., Bainbridge Island, WA (US)

(72) Inventors: Eric Thompson, Bainbridge Island, WA (US); Wade Kempf, Bremerton, WA (US)

(21) Appl. No.: 17/253,560

(22) PCT Filed: Jun. 18, 2019
(86) PCT No.: PCT/US19/37623

§ 371 Date: Dec. 17, 2020

Related U.S. Application Data
(60) Provisional application No. 62/763,449, filed on Jun. 18, 2018.

(51) Int. Cl. G06F 21/44; G06F 21/82; G06F 21/71; G06F 21/57; G06F 21/62

(52) U.S. Cl. CPC G06F 21/44; G06F 21/82; G06F 21/71; G06F 2221/2129; G06F 21/6218; G06F 2221/034; G06F 2221/2103; G06F 21/57

(57) ABSTRACT

A computer security system may include an endpoint authentication interface configured to receive one or more user credentials, an endpoint enrollment controller operatively connected to the endpoint authentication interface, and an endpoint access controller operatively connected to the endpoint enrollment controller and configured to enable or disable one or more data connections between a protected device and an endpoint terminal system. An interface interrogator device may receive data from a slave device, analyze the data, and in response to determining whether the slave device is authorized, enable or disable a connection between the slave device and a host device. The computer security system may include the interface interrogator device to further enable or disable connections between the protected device and the endpoint terminal system. Methods of controlling connections between a host computer and a slave device are also disclosed herein. Cable management systems are also disclosed herein.

### CROSS-REFERENCE TO RELATED APPLICATION

The present application claims priority to U.S. Provisional Patent Application No. 62/763,449, filed Jun. 18, 2018, which is incorporated herein by reference in its entirety.

### TECHNICAL FIELD

The present technology is directed generally to systems and methods for computer security. For example, the present technology is directed to providing air gap security between endpoint terminals and protected devices, or between slave (peripheral) devices and host devices (computers).

### BACKGROUND

Prevention of unauthorized access to computer systems is paramount for many individuals and organizations interested in security. Despite the nearly ubiquitous use of passwords to control user access, many computer systems remain vulnerable to unauthorized access. For example, many computer systems and networks include one or more endpoints where human users engage with user interface devices such as keyboards, mice, monitors, voice controls, or other devices. These endpoints may be vulnerable to unauthorized access or tampering because malware may be injected into the computer systems via physical ports such as Universal Serial Bus (USB), High-Definition Multimedia Interface (HDMI) or other ports in which the user interface devices connect to the computing systems.

### BRIEF DESCRIPTION OF THE DRAWINGS

Many aspects of the present disclosure can be better understood with reference to the following drawings. The components in the drawings are not necessarily to scale. Instead, emphasis is placed on clearly illustrating the principles of the present disclosure. The same reference number indicates the same element throughout the several views.

FIG. 1 is a partially schematic view of a computer security system configured in accordance with embodiments of the present technology.

FIG. 2 is a simplified schematic view of portions of the computer security system shown in FIG. 1.

FIG. 3 is a partially schematic view of an interface interrogator device connecting a host computer and one or more slave devices, the interface interrogator device configured in accordance with embodiments of the present technology.

FIG. 4 is a flow diagram illustrating an interrogation and connection process that may be carried out by instructions programmed in the interrogation chip and/or the control chip.

FIG. 5 is a block diagram of a multi-user or multi-endpoint computer security system configured in accordance with embodiments of the present technology.

FIG. 6 illustrates a portion of a multi-user or multi-endpoint computer security system configured in accordance with embodiments of the present technology.

FIG. 7 illustrates a cable retention system configured in accordance with embodiments of the present technology.

FIG. 8 illustrates a retention block having a plurality of retention rail extrusions configured in accordance with embodiments of the present technology.

FIG. 9 illustrates a cable retention system with a set screw, configured in accordance with embodiments of the present technology.

FIG. 10 is a block diagram illustrating an example of the architecture for a computer system or other control device that can be utilized to implement various portions of the present technology.

### DETAILED DESCRIPTION

The present technology is directed generally to systems and methods for computer security. For example, in one embodiment of the present technology, a computer security system may include an endpoint authentication interface configured to receive one or more user credentials, an endpoint enrollment controller operatively connected to the endpoint authentication interface, and an endpoint access controller operatively connected to the endpoint enrollment controller and configured to enable or disable one or more data connections between a protected device and an endpoint terminal system. The endpoint enrollment controller may be programmed with instructions that receive the one or more user credentials from the endpoint authentication interface and send a signal to the endpoint access controller to cause the endpoint access controller to enable or disable the one or more data connections. The one or more data connections may include connections between the protected device and a keyboard, a mouse, or a monitor. The protected device may include a host computer, a server, a network link, or a storage device. In some embodiments, the protected device may not be connected to an external system outside of a secured computing system that includes the protected device, and/or the endpoint access controller may not be connected to an external system outside of the secured computing system. The system may further include one or more additional endpoint access controllers configured to enable or disable one or more additional data connections between the protected device and one or more additional endpoint terminal systems.

In another embodiment of the present technology, the system may further include an interface interrogator device operatively connected to the endpoint access controller, and/or operatively connected between a user interface device (such as a keyboard, a mouse, a monitor, a mass storage device, and/or another peripheral device) and the protected device. The interface interrogator device may include a controller programmed with instructions that, when executed, determine if a user interface device is authorized to connect with the protected device, and in response to determining if the user interface device is authorized to connect with the protected device the interface interrogator device may enable or disable communication between the user interface device and the protected device. In some embodiments, when the user interface device comprises a mass storage device, the interface interrogator device is configured to prevent or disable communication between the mass storage device and the protected device.

In still another embodiment of the present technology, an interface interrogator device includes a plurality of connectors, wherein at least one first connector is configured to engage with a host port of a computing device, and wherein at least one second connector is configured to engage with a slave device. The interface interrogator device may further include an interrogation chip connected to the second connector and configured to receive data from the slave device. The interface interrogator device may further include a control chip connected to the interrogation chip, the control chip further being connected to the at least one first connector and programmed with instructions that enable or disable a connection between the slave device and the host port of the computing device. In some embodiments, the data from the slave device includes a slave device type, a slave device manufacturer, and/or a slave device product identification number. The connectors may be USB, HDMI, ethernet connectors, and/or other connectors for transmission of data. The control chip and/or the interrogation chip is programmed with instructions that, when executed, analyze the data from the slave device, determine whether the slave device is an authorized device, and, depending on the determination of whether the slave device is an authorized device, enable or disable the connection. For example, the interface interrogator device may disable the connection when the slave device type indicates a mass storage device.

In still another embodiment of the present technology, a method of controlling connections between a host computer and a slave device (such as a user interface device, peripheral device, mouse, keyboard, monitor, or the like) includes identifying a slave device using an interrogation chip by receiving, in the interrogation chip, data that identifies the slave device. The method may further include determining, based on the data that identifies the slave device, whether the slave device is an authorized device, and if the slave device is an authorized device, sending an approval signal from the interrogation chip to a control chip. The control chip may establish a connection between the host computer and the slave device based on the approval signal. In some embodiments, the method may include monitoring the connection, and if the slave device is removed or modified, disabling the connection and re-determining whether the slave device is an authorized device before re-enabling the connection or before permitting re-enablement of the connection.

In yet another embodiment of the present technology, a cable management system includes a retention rail having an elongated track with a groove. The system may further include a retention block with a body and an extrusion carrier extending from the body, the extrusion carrier configured to engage the groove with one or more retention rail extrusions extending from the extrusion carrier. The retention block receives one or more cables. The retention block may be movable along the track and/or the retention block may include a set screw passing through at least part of the retention block to selectively press against the retention rail to resist or prevent movement of the retention block. The retention block may include a channel passing through the retention block and configured to receive a cable tie element that may hold one or more cables in and/or on the retention block. The one or more retention rail extrusions may include two or more retention rail extrusions positioned to engage the retention block in a selected number of positions in the groove to provide adjustment to height and/or positioning of the one or more cables.

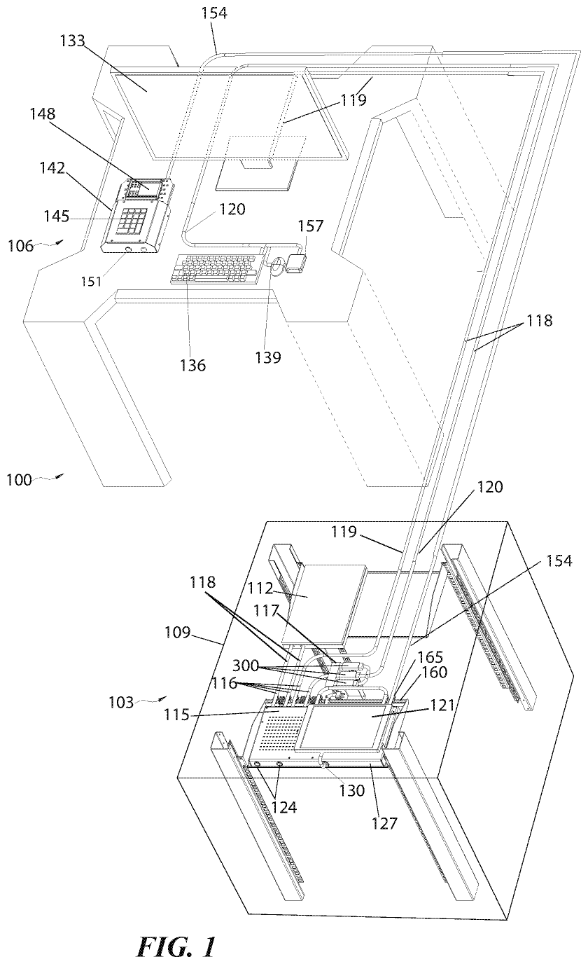

Various embodiments of the technology are described herein. The following description provides specific details for a thorough understanding and an enabling description of these embodiments. One skilled in the art will understand, however, that the technology may be practiced without many of these details. Additionally, some well-known structures or functions, such as those associated with computer terminals, computer networking, and printed circuit boards, may not be shown or described in detail for efficiency and to avoid unnecessarily obscuring the relevant description of the various embodiments. Accordingly, the technology may include other embodiments with additional elements or without several of the elements described below with reference to FIGS. 1-10.

The terminology used in the description presented below is intended to be interpreted in its broadest reasonable manner, even though it is being used in conjunction with a detailed description of certain specific embodiments of the technology. Certain terms may even be emphasized below; however, any terminology intended to be interpreted in any restrictive manner will be overtly and specifically defined as such in this detailed description section.

Many embodiments of the present technology may take the form of computer- or controller-executable instructions, including routines executed by a programmable computer or controller. Those skilled in the relevant art will appreciate that the technology can be practiced on computer/controller systems other than those shown and described below. The technology can be embodied in a special-purpose computer, controller or data processor that is specifically programmed, configured or constructed to perform one or more of the computer-executable instructions described below. Accordingly, the terms “computer” and “controller” as generally used herein refer to any data processor or data processing device and can include Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including a CRT display or LCD.

The technology can also be practiced in distributed environments, where tasks or modules are performed by remote processing devices that are linked through a communications network. In a distributed computing environment, program modules or subroutines may be located in local and remote memory storage devices. Aspects of the technology described below may be stored or distributed on computer-readable media, including magnetic or optically readable or removable computer disks, as well as distributed electronically over networks. Data structures and transmissions of data particular to aspects of the technology are also encompassed within the scope of the embodiments of the technology.

Systems and methods in accordance with embodiments of the present technology isolate users and endpoints from data resources intended to be secure and/or protected until users and endpoints have been properly authenticated. Such isolation can be colloquially deemed “air gap” security.

### A. COMPUTER SECURITY SYSTEMS FOR MANAGING ACCESS TO A PROTECTED DEVICE BY AN ENDPOINT TERMINAL

FIG. 1 is a partially schematic view of a computer security system 100 configured in accordance with embodiments of the present technology. The computer security system 100 may include a secured computing system 103 operatively connected to an endpoint terminal system 106 for securely accessing the secured computing system 103. A user seeking to access the secured computing system 103 may access the secured computing system 103 via the endpoint terminal system 106.

The secured computing system 103 may be physically secured in an enclosure 109, such as a room, a locked container, or another suitable enclosure. The secured computing system 103 may include a protected device 112, such as a host computer, network link, or other device, that contains secure data or enables a data connection to another secure system. The protected device 112 may generally include any device that is desired to be protected from unauthorized access, such as a server, a hard drive, a network connection, a controller for equipment, or the like. For example, in one particular embodiment, the protected device 112 may be a secure computer with sensitive commercial or intelligence data. In some embodiments, the protected device 112 is not connected to any external system other than the endpoint terminal system 106 (for example, the protected device 112 may not be connected to the World Wide Web or another external network).

The secured computing system 103 may further include an endpoint access controller 115, which enables or disables (such as turns on or turns off) the protected device 112 and/or connections 118 between the protected device 112 and the endpoint terminal system 106, such as network, HDMI 119, USB 120, and/or other network and/or data connections, such as Ethernet. The endpoint access controller 115 functions as a gateway between the protected device 112 and the endpoint terminal system 106. For example, when the endpoint access controller 115 has activated (enabled) one or more connections 118 to the protected device 112, the endpoint terminal system 106 can access and/or control the protected device 112. To facilitate connecting the protected device 112 to the endpoint terminal system 106, the endpoint access controller 115 may include one or more input/output ports 116 (such as HDMI, USB, Ethernet, and/or other input ports), which are connected to the protected device 112 or to the endpoint terminal system 106. In operation, the endpoint access controller 115 enables or disables activity across the input/output ports 116, thereby enabling or disabling the connections 118 (e.g., HDMI 119, USB 120) between the protected device 112 and the endpoint terminal 106. In some embodiments, the endpoint access controller 115 is not connected to any external system other than the endpoint terminal system 106, and it may be secured within the enclosure 109, to prevent unauthorized access or alteration. In some embodiments, the endpoint access controller 115 may connect to multiple protected devices 112 and multiple endpoint terminals 106 to enable or disable connections between one or more endpoint terminals 106 and one or more protected devices 112. In some embodiments, the secured computing system 103 may further include a hub device 117, which may include a USB hub, an HDMI hub, or another suitable data hub for connecting multiple data connections in a bus arrangement.

In some embodiments, an endpoint enrollment controller 121 may be configured to control whether the endpoint access controller 115 has enabled or disabled the connections 118 between the protected device 112 and the endpoint terminal system 106. For example, the endpoint enrollment controller 121 may receive enrollment credentials about a user, it may authenticate the user, and it may send a signal to the endpoint access controller 115 to enable the connections 118 between the protected device 112 and the endpoint terminal system 106, based on authenticating the user. In some embodiments, the endpoint access controller 115 may include manual on/off buttons 124 to manually enable or disable the connections 118 between the protected device 112 and the endpoint terminal system 106. In some embodiments, the endpoint access controller 115 may be positioned in a rack-mountable enclosure 127, so that the endpoint access controller 115 may be supported in a modular manner in the overall enclosure 109. In some embodiments, the rack-mountable enclosure may be approximately nineteen inches wide, and/or it may have other suitable dimensions.

The endpoint enrollment controller 121 may include a computing device such as a small computer or tablet device running an operating system (such as WINDOWS 10 by MICROSOFT, or another suitable operating system) that manages user enrollment and/or access control to the protected device 112. In some embodiments, the endpoint enrollment center 121 may connect to the endpoint access controller 115 via a data connection 130, such as USB or another suitable data connection. In some embodiments, the endpoint enrollment controller 121 is not connected to any external network, such that the endpoint enrollment controller 121 may only be controlled locally (for example, within the enclosure 109 by an embedded touch screen or other input device) to prevent unauthorized alterations to the endpoint enrollment controller 121.

In some embodiments, one or more of the components of the secured computing system 103 may be positioned outside of the enclosure 109, for example, in another enclosure, another secure location or environment, or in other locations (local or remote), depending on the level of security desired by the system operators.

In some embodiments, the endpoint terminal system 106 is an end user's access point for accessing data or signals on the protected device 112. The endpoint terminal system 106 may include one or more user interface devices, such as one or more monitors 133 for viewing data associated with the protected device 112. Other user interface devices of the endpoint terminal system 106 may include one or more keyboards 136, one or more mice 139, or other user interface devices suitable for interacting with computer systems such as the protected device 112. The user interface devices (such as the one or more keyboards 136, one or more mice 139, one or more monitors 133) may be connected to the secured computing system 103 via one or more USB connections 120, HDMI connections 119, or other suitable audio, video, or control connections.

The endpoint access controller 115 enables or disables connections 118 (including HDMI connections 119, USB connections 120, or other connections) between the user interface devices 133, 136, 139 and the protected device 112. In some embodiments, the endpoint access controller 115 provides an “air-gap” (either physical or electronic) that separates the protected device 112 from connections until connections are authorized. In some embodiments, to control enabling or disabling of the connections 118, a user provides credentials or authentication at the endpoint terminal system 106. The endpoint terminal system 106 may include an endpoint authentication interface 142 configured to receive user credentials and transmit the user credentials to the endpoint enrollment controller 121 for verification. In some embodiments, the endpoint authentication interface 142 may include a keypad 145 (which may include alphanumeric keys or other symbolic keys) for receiving a user passcode, personal identification number (“PIN”), or other entry for verifying a user's identity. In some embodiments, the endpoint authenticator interface 142 may include one or more biometric authentication devices such as a fingerprint scanner or facial recognition scanner. In some embodiments, the endpoint authentication interface 142 may additionally or alternatively include a card reader 148, which may be a swipe card reader, a contactless card reader, or another card reader similar to existing access card readers (sometimes called “smart” cards or radio-frequency identification cards). Information read or entered in the card reader 148 and/or the keypad 145 may be transmitted by the endpoint authentication interface 142 to the endpoint enrollment controller 121 for verification, and depending on whether a user has been authenticated and authorized, the endpoint enrollment controller 121 may instruct the endpoint access controller 115 to enable connections 118 between the user interface devices 133, 136, 139 and the protected device 112.

In some embodiments, the endpoint terminal system 106 may include a kill button 151, which in some embodiments may be positioned on and/or connected to the endpoint authentication interface 142. The kill button 151 may be configured to transmit a signal to the endpoint enrollment controller 121 to instruct the endpoint enrollment controller 121 to further instruct the endpoint access controller 115 to disable connections 118 with the protected device 112. Accordingly, the kill button 151 may function as an instant log-out button. In some embodiments, the kill button 151 may include a manual button and/or it may be accomplished by removal of a user's credentials (such as an access card) from the endpoint authentication interface 142.

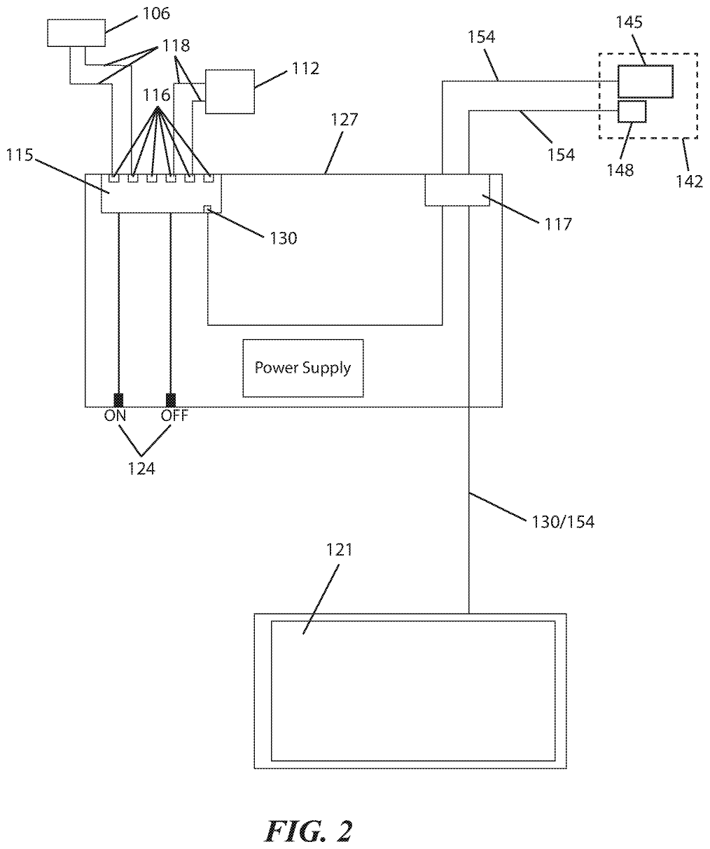

FIG. 2 is a simplified schematic view of portions of the computer security system 100 illustrated in FIG. 1. For example, as best seen in FIG. 2, the hub 117 may interconnect the endpoint authentication interface 142 (which may have the keypad 145 and the card reader 148), the endpoint enrollment controller 121, and the endpoint access controller 115.

Referring to FIGS. 1 and 2 together, in operation, a user desiring access to the protected device 112 may operate the endpoint authentication interface 142 (for example, by operating the keypad 145 and/or providing an identification and/or access card to the card reader 148), which sends the user's authentication information to the endpoint enrollment controller 121 via an endpoint authenticator connection 154, which may include a USB connection, ethernet connection, or another suitable data connection, and may include the hub 117. Upon receipt of the user's credentials at the endpoint enrollment controller 121, the endpoint enrollment controller 121 determines whether the user is authorized. Upon determination of authority to access the protected device 112, the endpoint enrollment controller 121 instructs the endpoint access controller 115 to enable the connections 118 and/or to turn on or otherwise activate the protected device 112.

In other words, in operation, the endpoint terminal system 106 cannot access the protected device 112 unless and until the user provides authentication credentials at the endpoint authentication interface 142, those credentials are verified at the endpoint enrollment controller 121, and the endpoint enrollment controller 121 instructs the endpoint access controller 115 to enable the connections 118, which link the monitor 133, the keyboard 136, the mouse 139, and other peripherals or controllers to the protected device 112. In some embodiments, upon connecting the endpoint terminal system 106 with the protected device 112 (via the enablement of connections 118 by the endpoint access controller 115), a user may further be required to log in to the protected device 112. For example, as shown in FIG. 1, the endpoint terminal system 106 may further include an additional authenticator device 157, such as a contact card reader, keypad, or other authenticator device, to communicate additional credential information to the protected device 112.

Embodiments of the present technology provide multiple layers of security. For example, in order to even communicate with the protected device 112, a user must be authenticated at the endpoint terminal system 106, and in order to access data on the protected device 112, a user may be further required to log in to the protected device 112. The present technology provides an air gap security arrangement that prevents all access to the protected device 112 without authorization. Before a user authenticates at the endpoint authentication interface 142, the protected device 112 is not even connected to the endpoint terminal system 103. The present technology accordingly completely blocks access to the actual interfaces of the protected device 112, including video and input interfaces, or other interfaces.

### B. Interface Interrogator Devices

One potential vulnerability in computer systems is that nearly any data connection may provide a pathway for malware or other intrusions. For example, a nefarious party may simply plug a USB device into a USB port on a computer system (or another device in another data port) and activate instructions or code to inject malware or seize control of the computer system. Embodiments of the present technology provide interface interrogator devices to block malicious or otherwise unwanted data traffic to and/or from a computer system that is desired to be protected.

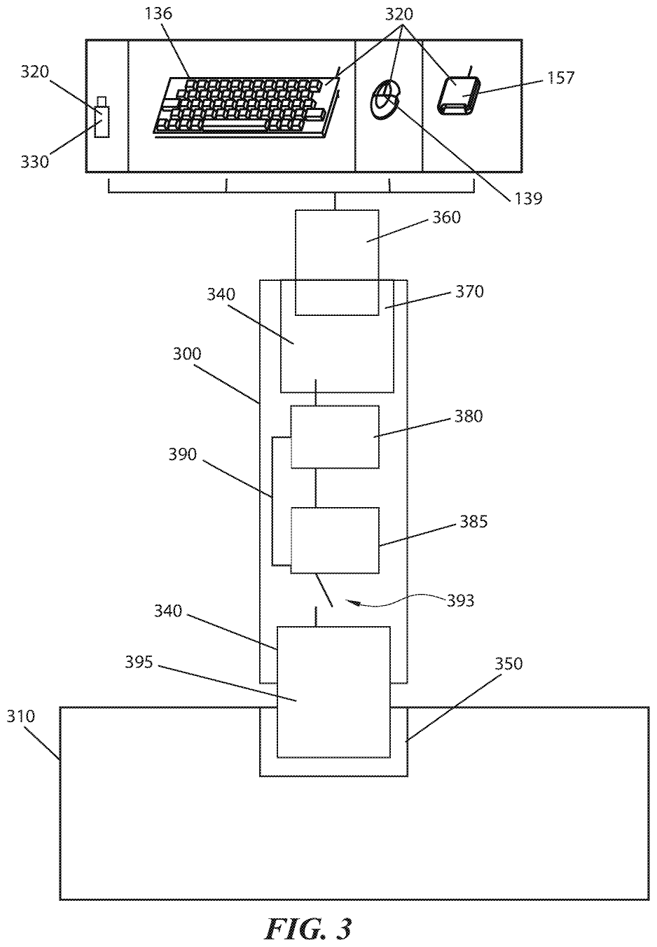

FIG. 3 is a partially schematic view of an interface interrogator device 300 connecting a host computer 310 and one or more slave devices 320, the interface interrogator device 300 being configured in accordance with embodiments of the present technology. The host computer 310 may be a computer that is desired to be protected, for example, the protected device 112 described above (FIG. 1 shows three interface interrogator devices 300 implemented in a security system 100). The one or more slave devices 320 may include one or more peripheral or other devices capable of being connected to the host computer for control or communication. For example, the one or more slave devices 320 may include a keyboard 136, a mouse 139, an authenticator device 157, and/or a mass storage device 330 (such as a flash drive, hard drive, or other storage device). In some embodiments, the devices 320 and the interface interrogator device 300 may be configured to communicate with the host computer 310 using USB protocols, or other suitable data communication protocols.

As explained in additional detail below, the interface interrogator device 300 may be configured to allow data traffic between some devices, such as the keyboard 136, the mouse 139, and the authenticator device 157, while the interface interrogator device 300 may be further configured to deny data traffic to and from the mass storage device 330 in order to prevent injection of malware or other undesirable code or instruction into the host computer 310. The interface interrogator device 300 analyzes data traffic and connections between devices and determines if devices should be allowed to communicate, by distinguishing between allowed devices such as human interface devices (mice, keyboards, etc.) and banned devices such as mass storage devices. In some embodiments, the interface interrogator device 300 is configured to be a single device capable of plug-and-play configuration, in which it may merely be operatively connected between the host computer 310 and the one or more slave devices 320. For example, the interface interrogator device 300 may be in the form of a dongle, adapter, or other intermediate connector.

In some embodiments, the interface interrogator device 300 includes a plurality of connectors 340 (such as two USB connectors 340, or other suitable data connectors, such as HDMI, ethernet, or others). The connectors 340 may be male connectors, female connectors, androgynous connectors, or other connectors suitable for engaging with a corresponding connector, such as a host port 350 and one or more slave devices 320. For example, in one particular embodiment, a first connector 340 may be a male USB connector for connecting to a corresponding female USB connector in the host computer 310, while a second connector 340 may be a female USB connector for receiving a corresponding male USB connector 360 associated with a slave device 320.

The interface interrogator device 300 includes a host interface 370 associated with a connector 340, to function as a host for the slave device 320. The host interface 370 is operatively connected to an interrogation chip 380, which requests and/or receives data from the slave device 320. The interface interrogator device 300 further includes a control chip 385 connected to the interrogation chip 380. In some embodiments, a control and monitor connection 390 facilitates communication between the interrogation chip 380 and the control chip 385. The control chip 385 functions as a latch (schematically illustrated as latch 393) to enable or disable a connection between the host interface 370 of the interface interrogator device 300 and a slave interface 395 associated with the connector 340 that engages the host computer 310. In some embodiments, the control chip 385 features a hardware gate allowing or disallowing physical connections, while in other embodiments, the latch 393 is embodied in software. The interface interrogator device 300 blocks all connections to the host computer 310 from passing through the interface interrogator device 300 until the slave devices 320 are verified and/or authorized.

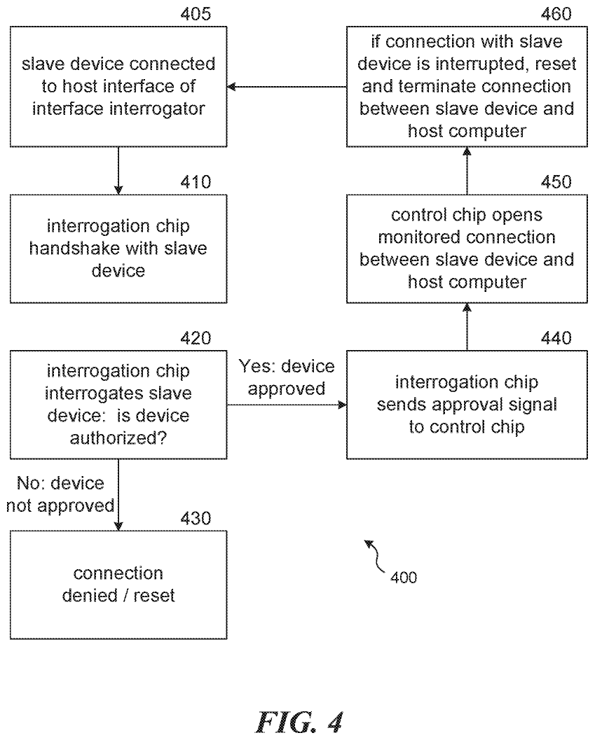

FIG. 4 is a flow diagram illustrating an interrogation and connection process 400 that may be carried out by instructions programmed in and executed by the interrogation chip 380 and/or the control chip 385. Beginning at block 405, a slave device 320 (see FIG. 3) is connected to the host interface 370 of the interface interrogator device 300. For example, a keyboard 136, mouse 139, authenticator device 157, mass storage device 330, or other slave device 320 may be plugged into the host interface 370, such as by connecting USB connectors 340, 360. In some embodiments, the slave device 320 may be connected to the host interface 370 by an intermediate extension cable. In some embodiments, prior to the slave device 320 being connected to the host interface 370, the interface interrogator device 300 may be in a watchdog mode, waiting for connection with a slave device 320.

Upon connection between the slave device 320 and the host interface 370, at block 410, the interrogation chip 380 carries out a handshake or enumeration to link the interface interrogator device 300 with the slave device 320. In block 420, optionally in response to an interrogation query by the interrogation chip 380, the slave device identifies itself to the host by device type, manufacturer identification, and/or product identification. The interrogation chip 380 determines whether the slave device 320 is an authorized device. If the slave device 320 is not an authorized device, at block 430 the interrogation chip does not send an approval signal to the control chip 385, so the control chip 385 does not establish a connection between the slave device 320 and the host port 350 of the host computer 310. The interrogation chip 380 may reset and wait for another slave device 320 to be connected to the host interface 370 of the interface interrogator device 300 to begin the authorization process again.

If the slave device 320 is an authorized device, at block 440 the interrogation chip 380 sends an approval signal to the control chip 385. In response, at block 450 the control chip 385 opens a monitored physical connection between the slave device 320 and the host port 350 of the host computer 310. For example, as shown in FIG. 3, the control and monitor connection 390 may facilitate communication of data between the interrogation chip 380 and the control chip 385 regarding whether the connection between the slave device 320 and the host interface 370 persists. Again, referring to FIG. 4, at block 460, if the connection between the slave device 320 and the host interface 370 is interrupted (for example, if an attempt is made to replace an authorized slave device 320 with an unauthorized slave device 320, the interrogation and connection process 400 resets and the control chip 385 closes the connection between the slave device 320 and the host computer 310.

In some embodiments, when the interface interrogator device 300 is authorizing a connection between the slave device 320 and the host computer 310, the host computer 310 may be engaged in a communication mode appropriate for the specific authorized slave device 320. If an unauthorized slave device 320 is swapped for an authorized slave device 320, the interface interrogator device 300 ends the connection. If a previously authorized slave device 320 attempts to switch states (for example, by masquerading as an authorized slave device, such as a mouse, and then beginning function as a mass storage device), the interface interrogator device 300 may detect the new communication mode and end the connection, restarting the interrogation at block 405.

In other words, the interrogation chip 380 and the control chip 385 of the interface interrogator device 300 together carry out a latch function, in which the interrogation chip 380 analyzes devices and instructs the control chip 385 to enable or disable a physical connection between devices. If any changes are detected by either the interrogation chip 380 or the control chip 385, connections are cut and the interrogation process begins again. Accordingly, the interface interrogator device 300 provides layered security, by analyzing slave devices 320 and allowing or disallowing connections based on the type of device (for example, mass storage devices may not be allowed to be connected), manufacturer information, product information, model information, or other characteristics suitable for determining whether a slave device 320 is acceptable.

The interrogation chip 380 may be programmed with instructions that determine whether a device is authorized. In some embodiments, the interface interrogator device 300 may include embedded machine-learning instructions that reduce or eliminate the need to individually program what slave devices 320 are to be allowed or disallowed. For example, the interface interrogator device 300 may include a controller with instructions that, when executed, enable a learning mode in which permitted slave devices 320 are connected to the interface interrogator device 300 to teach the interface interrogator device 300 what devices are allowed. The interface interrogator device may further include a controller with instructions that, when executed, enable operational mode to carry out the regular function of the interface interrogator device 300. In some embodiments, the interface interrogator device 300 may include a switch to activate and/or deactivate the learning mode, and/or it may include an interface for a user to enter a code to activate or deactivate the learning mode.

Interface interrogator devices 300 configured in accordance with embodiments of the present technology, in which interrogation software is hard-coded into the chips 380, 385, have several advantages over software-only solutions. For example, software-based port security running on a general operating system may be compromised if the operating system is compromised. In contrast, the physical interface interrogator devices 300 may be configured to lack general operating systems, programming interfaces, or other accessible or alterable code. Physical interface interrogator devices 300 may include a printed circuit board carrying the chips 380, 385. In addition, interface interrogator devices 300 may function as a self-supporting appliance positioned between a secured device and a peripheral to block introduction of all malware and/or data storage devices.

### C. MULTI-ENDPOINT SECURITY SYSTEMS

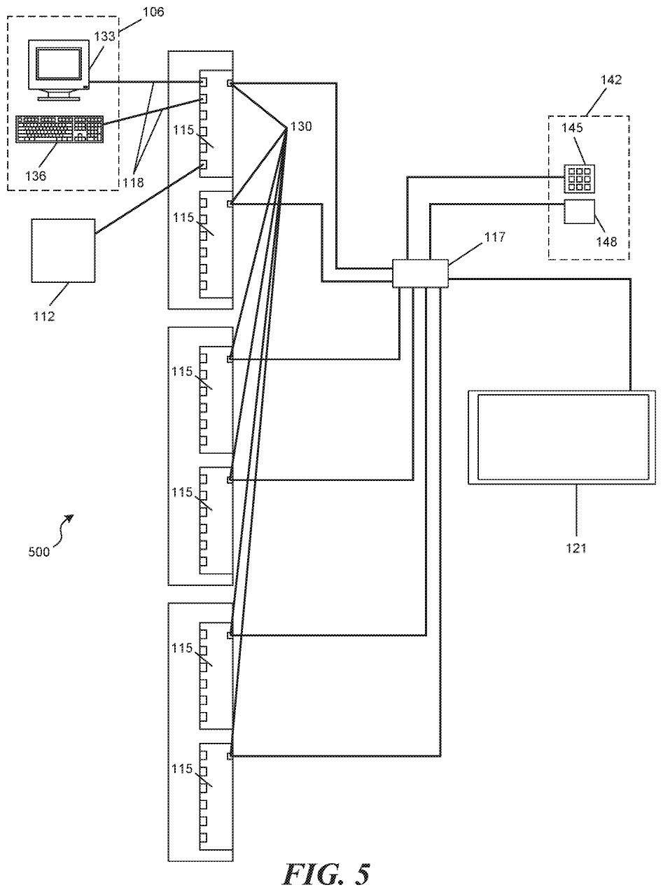

Systems and methods of securing computer systems configured in accordance with embodiments of the present technology may be scaled up to provide for multiple endpoints and/or multiple users. For example, FIG. 5 is a block diagram of a multi-user or multi-endpoint computer security system 500 configured in accordance with embodiments of the present technology. A single endpoint authentication interface 142 may be connected to a single endpoint enrollment controller 121 via a single hub device 117, which serves as a hub for a plurality of endpoint access controllers 115 (which are similar to the endpoint access controllers 115 described above with regard to FIGS. 1 and 2). Each endpoint access controller 115 may enable or disable connections between one or more protected devices 112 (each endpoint access controller 115 may be connected to the same or different protected devices 112) and one or more endpoint terminal systems 106, having terminal elements described above such as a monitor 133, keyboard 136, or other elements of endpoint terminal systems 106 described above (such as mice or card readers). Accordingly, a single secured computing system 103 (see FIG. 1) may serve multiple endpoint terminal systems 106 (see FIG. 1).

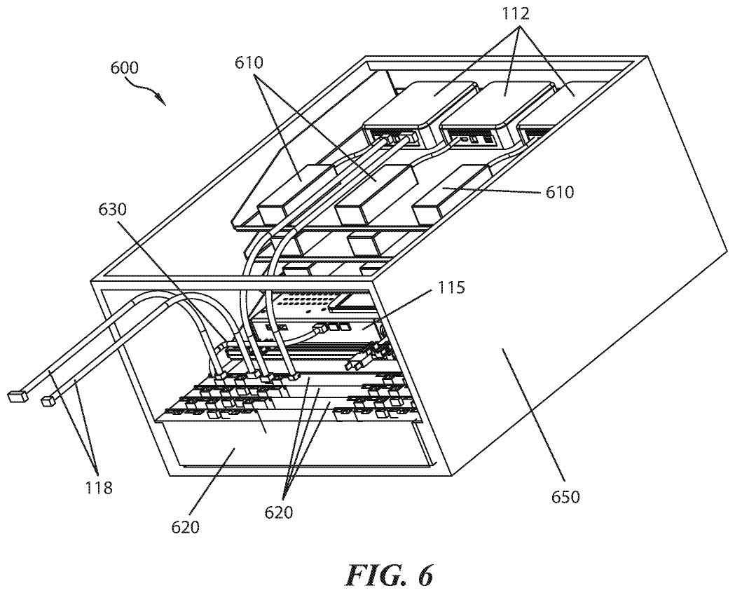

FIG. 6 illustrates a portion of a multi-user or multi-endpoint computer security system 600 configured in accordance with embodiments of the present technology. The multi-user or multi-endpoint security system 600 may include one or more (such as a plurality) of protected devices 112, each powered by its own power supply 610 (although in some embodiments, protected devices 112 may share one or more power supplies 610). The system 600 facilitates serving multiple users or multiple endpoint terminal systems 106 from a single installation of the system 600. The system 600 may include one or more (such as a plurality) of multi-user endpoint access controllers 620, which may be similar to the endpoint access controllers 115 described above. The multi-user endpoint access controllers 620 may enable or disable access to a plurality of protected devices 112 by a plurality of users or endpoint terminal systems. For example, in some embodiments, a multi-user control cable 630 may connect one or more endpoint access controllers 115 (which may be networked to each other) to a primary access controller 115 that controls the multi-user endpoint access controllers 620. The multi-user control cable 630 facilitates simultaneous and/or independent control of all protected devices 112 (which in some embodiments may be cloud computing devices). Accordingly, in some embodiments, the endpoint authentication interface 142 (see FIGS. 1 and 5), may activate one or more client devices (connected with connections 118 described above, such as HDMI, USB, or other connections to client devices) simultaneously or individually.

In some embodiments, the system 600 may include an enclosure 650 to contain the protected devices 112, the power supplies 610, the endpoint access controllers 620, and the primary access controller 115 in a compact and space-efficient design. For example, the endpoint access controllers 620 may be oriented vertically and stacked alongside each other (as shown in FIG. 6) and perpendicular to the protected devices 112, which improves density and organization in the enclosure 650. Cables may be managed to be efficiently organized to further improve density within the enclosure 650, which further reduces overall footprint of the system 600 and therefore reduces cost of the system 600 (secure spaces within security containers is generally expensive).

### D. CABLE RETENTION SYSTEMS

Cable retention or management systems configured in accordance with embodiments of the present technology facilitate fast and accurate cable insertion and connection with improved organization and resistance to tampering. Referring back to FIG. 1, cable retention systems configured in accordance with embodiments of the present technology may include one or more retention rails 160, which may be positioned and/or supported within the enclosure 109. The retention rails 160 support one or more movable and/or slidable retention blocks 165. The retention blocks 165 support one or more cables (such as the cables for connections 118, 154, or other cables) in an organized manner that aligns cables accurately in both the vertical and horizontal planes. Cable retention systems configured in accordance with embodiments of the present technology reduce risk of tampering by reducing slack in cables.

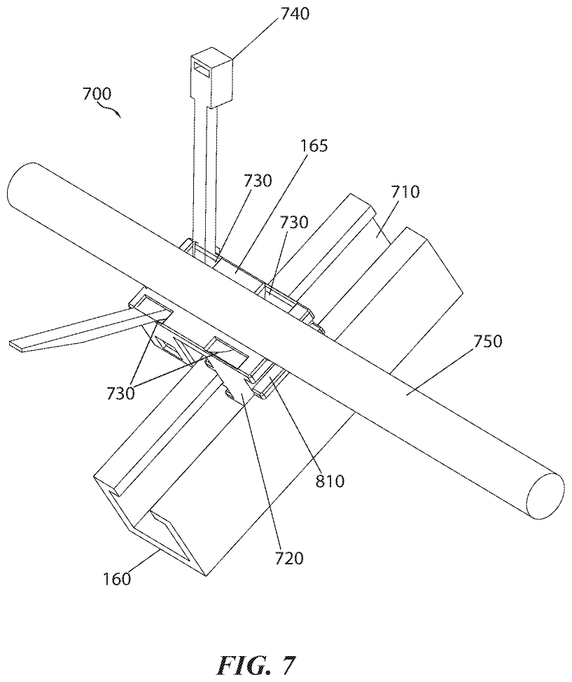

FIG. 7 illustrates a cable retention system 700 configured in accordance with embodiments of the present technology. The retention rail 160 may include an elongated track with a groove 710 positioned to receive an extrusion carrier 720 extending from a body of the retention block 165. In some embodiments, the retention rail 160 may be square, rectangular, oval, or other suitable shapes. The retention block 165 may include one or more tie-down insertion channels 730 (such as two tie-down insertion channels 730) shaped and sized to receive a common commercial cable tie element 740, such as a “zip tie.” The cable tie element 740 passes through the tie-down insertion channels 730 of the retention block 165 and around a cable 750 (which may be any cable for facilitating connections described herein, or other cables) to hold the cable 750 to the retention block 165, which may be repositionable along the retention rail 160. In some embodiments, the tie-down insertion channels 730 may be curved or otherwise oriented within the retention block 165 to cause the cable tie element 740 to pass into the retention block 165 and then bend upward and away from the retention block 165, to facilitate easier tying of the cable tie element 740.

Positioning the retention block 165 along a position of the retention rail 160 facilitates accurate positioning of the cable 750. In some embodiments, a cable retention system need not include a retention rail 160. Rather, in some embodiments, the retention block 165 may be attached to a surface using an adhesive, a fastener, or another suitable attachment.

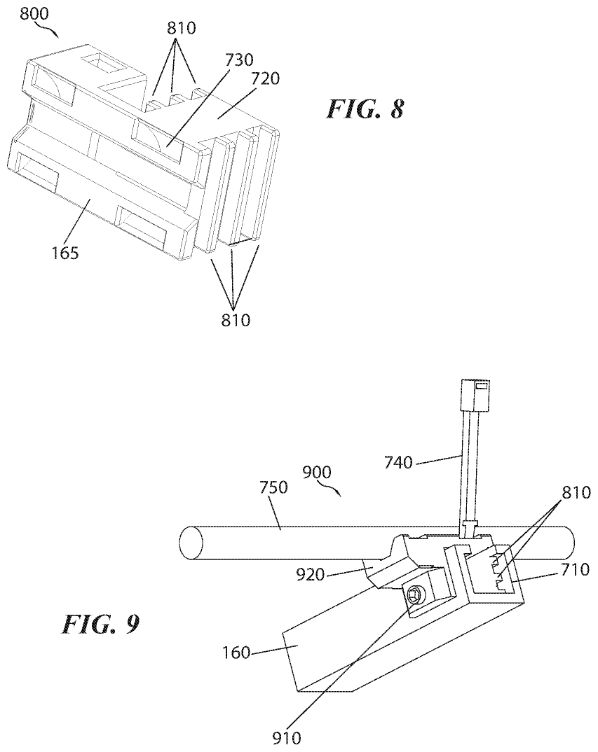

Retention blocks configured in accordance with embodiments of the present technology may be height-adjustable. For example, FIG. 8 illustrates a retention block 800 (which may be similar to the retention block 165 described above) having a plurality of retention rail extrusions 810 extending from the extrusion carrier 720. The retention rail extrusions 810 interface with the groove 710 of the retention rail 160 (see FIG. 7). The several retention rail extrusions 810 allow a user to select a height at which the retention block 165 holds the cable above the retention rail 160 (see FIG. 7). In some embodiments, the retention block 800 may have three height-adjustable levels, or it may have more or fewer height adjustable levels, depending on the quantity and positioning of the retention rail extrusions 810 on the extrusion carrier 720. In some embodiments, the extrusion carrier 720 and/or the retention rail extrusions 810 may be oriented along a length of the retention block 165, although in other embodiments, the extrusion carrier 720 and/or the retention rail extrusions 810 may be oriented along a width or height of the retention block 165, or the extrusion carrier 720 and/or the retention rail extrusion 810 may be oriented at an angle along the retention block 165. Positioning and orientation of the extrusion carrier 720 and/or the retention rail extrusions 810 facilitates customized and/or more precise positioning of the cable 750.

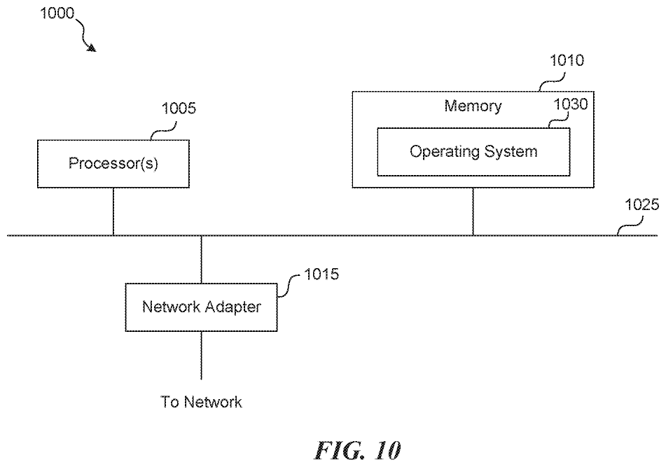

Retention blocks 165 configured in accordance with embodiments of the present technology may also be locked or at least partially locked against the retention rail to prevent lateral movement along the retention rail. For example, FIG. 9 illustrates a cable retention system 900 that is similar to the cable retention system 700 described above and shown in FIG. 7, but with a set screw 910 positioned to pass through the retention block 920 to press against the retention rail 160 and provide friction to resist or prevent sliding of the retention block 920 along the retention rail 160.

Although cable retention systems configured in accordance with embodiments of the present technology are described in the context of secured computing systems, cable retention systems may be used in other suitable implementations in which accurate and secure cable management is desired.

### E. SUITABLE COMPUTER ARCHITECTURES FOR IMPLEMENTING EMBODIMENTS OF THE PRESENT TECHNOLOGY

FIG. 10 is a block diagram illustrating an example of the architecture for a computer system or other control device 1000 that can be utilized to implement various portions of the present technology. In FIG. 10, the computer system 1000 includes one or more processors 1005 and memory 1010 connected via an interconnect 1025. The interconnect 1025 may represent any one or more separate physical buses, point to point connections, or both, connected by appropriate bridges, adapters, or controllers. The interconnect 1025, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 674 bus, sometimes referred to as “Firewire”. The interconnect 1025 may include any other interconnect suitable for connecting components and transmitting signals, including other connections disclosed herein.

The processor(s) 1005 may include central processing units (CPUs) to control the overall operation of, for example, a host computer. In certain embodiments, the processor(s) 1005 accomplish this by executing software or firmware stored in memory 1010. The processor(s) 1005 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 1010 can be or include the main memory of the computer system. The memory 1010 represents any suitable form of random-access memory (RAM), read-only memory (ROM), flash memory, or the like, or a combination of such devices. In use, the memory 1010 may contain, among other things, a set of machine instructions which, when executed by processor 1005, causes the processor 1005 to perform operations to implement embodiments of the present technology.

Also connected to the processor(s) 1005 through the interconnect 1025 is a (optional) network adapter 1015. The network adapter 1015 provides the computer system 1000 with the ability to communicate with remote devices, such as storage clients, and/or other storage servers, and may be, for example, an Ethernet adapter or Fiber Channel adapter, or adapters for other communication protocols disclosed herein.

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium,” as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic,” as used herein, can include, for example, programmable circuitry programmed with specific software and/or firmware, special-purpose hardwired circuitry, or a combination thereof.

### F. ADDITIONAL EXAMPLES

Several additional aspects of the present technology are set forth in the additional following examples.
1. A computer security system, comprising:
an endpoint authentication interface configured to receive one or more user credentials;
an endpoint enrollment controller operatively connected to the endpoint authentication interface; and
an endpoint access controller operatively connected to the endpoint enrollment controller and configured to enable or disable one or more data connections between a protected device and an endpoint terminal system.
2. The computer security system of example 1 wherein the endpoint enrollment controller is programmed with instructions that receive the one or more user credentials from the endpoint authentication interface and send a signal to the endpoint access controller to cause the endpoint access controller to enable or disable the one or more data connections.
3. The computer security system of examples 1 or 2 wherein the one or more data connections comprise connections between the protected device and a keyboard, a mouse, or a monitor.
4. The computer security system of any one of examples 1-3 wherein the protected device comprises a host computer, server, network link, or storage device.
5. The computer security system of any one of examples 1-4 wherein the protected device is not connected to an external system outside of a secured computing system that includes the protected device, and wherein the endpoint access controller is not connected to an external system outside of the secured computing system.
6. The computer security system of any one of examples 1-5 wherein the endpoint access controller comprises a manual button configured to enable or disable the one or more data connections.
7. The computer security system of any one of examples 1-6, further comprising a rack-mountable enclosure containing the endpoint access controller.
8. The computer security system of any one of examples 1-7 wherein the endpoint enrollment controller comprises a computer with an operating system and programmed with instructions that receive user enrollment credentials and determine whether a user is authenticated to access the protected device.
9. The computer security system of any one of examples 1-8 wherein the endpoint authentication interface comprises a keypad.
10. The computer security system of any one of examples 1-9 wherein the endpoint authentication interface comprises a card reader.
11. The computer security system of any one of examples 1-10, further comprising a kill button configured to generate and transmit a signal to the endpoint enrollment controller to instruct the endpoint enrollment controller to further instruct the endpoint access controller to disable the one or more data connections.
12. The computer security system of any one of examples 1-11, further comprising a hub device configured to interconnect one or more of the endpoint enrollment controller, the endpoint access controller, and the endpoint authentication interface.
13. The computer security system of any one of examples 1-12, further comprising one or more additional endpoint access controllers configured to enable or disable one or more additional data connections between the protected device and one or more additional endpoint terminal systems.
14. The computer security system of any one of examples 1-13, further comprising an interface interrogator device operatively connected to the endpoint access controller, the interface interrogator device including a controller programmed with instructions that, when executed, determine if a user interface device is authorized to connect with the protected device, and in response to determining if the user interface device is authorized to connect with the protected device, enabling or disabling communication between the user interface device and the protected device.
15. The computer security system of any one of examples 1-14 wherein when the user interface device comprises a mass storage device, the interface interrogator device is configured to prevent or disable communication between the mass storage device and the protected device.
16. An interface interrogator device comprising:
a plurality of connectors, wherein at least one first connector is configured to engage with a host port of a computing device, and wherein at least one second connector is configured to engage with a slave device;
an interrogation chip connected to the second connector and configured to receive data from the slave device; and
a control chip connected to the interrogation chip, the control chip further being connected to the at least one first connector and programmed with instructions that enable or disable a connection between the slave device and the host port of the computing device,
wherein the data from the slave device comprises a slave device type, a slave device manufacturer, or a slave device product identification number.
17. The interface interrogator device of example 16 wherein the plurality of connectors comprises a USB, HDMI, or ethernet connector.
18. The interface interrogator device of examples 16 or 17 wherein the control chip or the interrogation chip is programmed with instructions that, when executed, analyze the data from the slave device, determine whether the slave device is an authorized device, and, depending on the determination of whether the slave device is an authorized device, enable or disable the connection.
19. The interface interrogator device of any one of examples 16-18 wherein the connection is disabled when the slave device type indicates a mass storage device.
20. A method of controlling connections between a host computer and a slave device, the method comprising:
identifying a slave device using an interrogation chip, wherein identifying the slave device comprises receiving, in the interrogation chip, data that identifies the slave device;
determining, based on the data that identifies the slave device, whether the slave device is an authorized device;
if the slave device is an authorized device, sending an approval signal from the interrogation chip to a control chip;
using the control chip, establishing a connection between the host computer and the slave device based on the approval signal.
21. The method of example 20 wherein the data includes a slave device type, a slave device manufacturer, or a slave device product identification number.
22. The method of examples 20 or 21, further comprising monitoring the connection, wherein if the slave device is removed or modified, disabling the connection and re-determining whether the slave device is an authorized device before re-enabling the connection.
23. The method of any one of examples 20-22, further comprising enabling a learning mode with the interrogation chip in which data identifying the slave device is stored in a memory.
24. A cable management system, comprising:
a retention rail including an elongated track with a groove; and
a retention block, the retention block comprising a body and an extrusion carrier extending from the body, the extrusion carrier configured to engage the groove with one or more retention rail extrusions extending from the extrusion carrier,
wherein the retention blocks is configured to receive one or more cables.
25. The cable management system of example 24 wherein the retention block is movable along the track.
26. The cable management system of examples 24 or 25 wherein the retention block comprises a set screw passing through at least part of the retention block to selectively press against the retention rail to resist or prevent movement of the retention block.
27. The cable management system of any one of examples 24-26 wherein the retention block comprises a channel configured to receive a cable tie element, the channel passing through the retention block.
28. The cable management system of any one of examples 24-27 wherein the one or more retention rail extrusions includes two or more retention rail extrusions positioned to engage the retention block in a selected number of positions in the groove.

### G. CONCLUSION

Advantages of systems configured in accordance with embodiments of the present technology include protecting computing systems and/or networks from unauthorized access, preventing connection of devices that may contain malware, and relatively simple design which may require only minimal training for security officers and other staff to implement. Systems configured in accordance with embodiments of the present technology provide an “air gap” isolation to physically separate users from components and networks. Systems configured in accordance with embodiments of the present technology provide layered security, which facilitates overlaying an independent security layer on an existing system infrastructure. For example, one layer (such as a computer terminal) may facilitate or prevent access to another layer (such as a server). In some embodiments, failure of one layer will not compromise an entire secured computing system. In some embodiments, equipment may be secured in a secure enclave with locks and/or walls that are difficult to penetrate, in order to physically separate authorized and/or unauthorized users from the equipment.

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. Moreover, the various embodiments described herein may also be combined or separated to provide further embodiments. For example, the foregoing includes multiple components that may work together in a secured computing system or separate components, such as interface interrogator devices, endpoint access controllers, or other components disclosed herein, however, the components disclosed herein may be deployed as individual components in specific applications. In some embodiments, the endpoint enrollment controller and endpoint access controller may be combined or integrated into a single controller, or they may be components of a single device.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the term “and/or” when used in the phrase “A and/or B” means “A, or B, or both A and B.” A similar manner of interpretation applies to the term “and/or” when used in a list of more than two terms. Where the context permits, singular or plural terms may also include the plural or singular term, respectively. Additionally, the term “comprising” is used throughout to mean including at least the recited feature(s) such that any greater number of the same feature and/or additional types of other features are not precluded. To the extent any of the materials incorporated herein by reference conflict with the present disclosure, the present disclosure controls. It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

1. A computer security system, comprising:
an endpoint authentication interface configured to receive one or more user credentials;
an endpoint enrollment controller operatively connected to the endpoint authentication interface; and
an endpoint access controller operatively connected to the endpoint enrollment controller and configured to enable or disable one or more data connections between a protected device and an endpoint terminal system.

2. The computer security system of claim 1 wherein the endpoint enrollment controller is programmed with instructions that receive the one or more user credentials from the endpoint authentication interface and send a signal to the endpoint access controller to cause the endpoint access controller to enable or disable the one or more data connections.

3. The computer security system of claim 1 wherein the one or more data connections comprise connections between the protected device and a keyboard, a mouse, or a monitor.

4. The computer security system of claim 1 wherein the protected device comprises a host computer, server, network link, or storage device.

5. The computer security system of claim 4 wherein the protected device is not connected to an external system outside of a secured computing system that includes the protected device, and wherein the endpoint access controller is not connected to an external system outside of the secured computing system.

6. The computer security system of claim 1 wherein the endpoint access controller comprises a manual button configured to enable or disable the one or more data connections.

7. (canceled)

8. The computer security system of claim 1 wherein the endpoint enrollment controller comprises a computer with an operating system and programmed with instructions that receive user enrollment credentials and determine whether a user is authenticated to access the protected device.

9. The computer security system of claim 1 wherein the endpoint authentication interface comprises a keypad, a card reader, or a radio-frequency identification device.

10. (canceled)

11. The computer security system of claim 1, further comprising a kill button configured to generate and transmit a signal to the endpoint enrollment controller to instruct the endpoint enrollment controller to further instruct the endpoint access controller to disable the one or more data connections.

12. The computer security system of claim 1, further comprising a hub device configured to interconnect one or more of the endpoint enrollment controller, the endpoint access controller, and the endpoint authentication interface.

13. The computer security system of claim 1, further comprising one or more additional endpoint access controllers configured to enable or disable one or more additional data connections between the protected device and one or more additional endpoint terminal systems.

14. The computer security system of claim 1, further comprising an interface interrogator device operatively connected to the endpoint access controller, the interface interrogator device including a controller programmed with instructions that, when executed, determine if a user interface device is authorized to connect with the protected device, and in response to determining if the user interface device is authorized to connect with the protected device, enabling or disabling communication between the user interface device and the protected device.

15. The computer security system of claim 14 wherein when the user interface device comprises a mass storage device, the interface interrogator device is configured to prevent or disable communication between the mass storage device and the protected device.

16. An interface interrogator device, comprising:
a plurality of connectors, wherein at least one first connector is configured to engage with a host port of a computing device, and wherein at least one second connector is configured to engage with a slave device;
an interrogation chip connected to the second connector and configured to receive data from the slave device; and
a control chip connected to the interrogation chip, the control chip further being connected to the at least one first connector and programmed with instructions that enable or disable a connection between the slave device and the host port of the computing device,
wherein the data from the slave device comprises a slave device type, a slave device manufacturer, or a slave device product identification number.

17. (canceled)

18. The interface interrogator device of claim 16 wherein the control chip or the interrogation chip is programmed with instructions that, when executed, analyze the data from the slave device, determine whether the slave device is an authorized device, and, depending on the determination of whether the slave device is an authorized device, enable or disable the connection.

19. The interface interrogator device of claim 16 wherein the connection is disabled when the slave device type indicates a mass storage device.

20. A method of controlling connections between a host computer and a slave device, the method comprising:
identifying a slave device using an interrogation chip, wherein identifying the slave device comprises receiving, in the interrogation chip, data that identifies the slave device;
determining, based on the data that identifies the slave device, whether the slave device is an authorized device;
if the slave device is an authorized device, sending an approval signal from the interrogation chip to a control chip;
using the control chip, establishing a connection between the host computer and the slave device based on the approval signal.

21. The method of claim 20 wherein the data includes a slave device type, a slave device manufacturer, or a slave device product identification number.

22. The method of claim 20, further comprising monitoring the connection, wherein if the slave device is removed or modified, disabling the connection and re-determining whether the slave device is an authorized device before re-enabling the connection.

23. The method of claim 20, further comprising enabling a learning mode with the interrogation chip in which data identifying the slave device is stored in a memory.

24-28. (canceled)
